(19) United States
(12) Patent Application Publication
(10) Pub. No.: US 2009/0270120 A1
(43) Pub. Date: Oct. 29, 2009

(54) METHOD AND APPARATUS FOR SUPPRESSING A RESPONSE FROM A TERMINAL OPERATING IN A GROUP COMMUNICATIONS SYSTEM

(75) Inventor: Vincent Park, Budd Lake, NJ (US)

Correspondence Address: QUALCOMM INCORPORATED, 5775 MOREHOUSE DR., SAN DIEGO, CA, 92121, US

(73) Assignee: QUALCOMM INCORPORATED, San Diego, CA (US)

(21) Appl. No.: 12/304,259

(22) PCT Filed: Jul. 16, 2007
(86) PCT No.: PCT/US2007/073639

§ 371 Date: Jan. 15, 2009

Related U.S. Application Data
(60) Provisional application No. 60/830,855, filed on Jul. 14, 2006.

(51) Int. Cl. H04B 7/00

(52) U.S. Cl. 455/518

(57) ABSTRACT

An apparatus and associated method, wherein the method provided for facilitating receiving a request that requires a reply within a first time, determining a first maximum time to reply using a first criteria, wherein the maximum time to reply is less than the first time, and selecting a reply time, wherein the reply time is not greater than the maximum time to reply.

### FIELD

This invention relates to communications system and, more particularly, to method of suppressing unnecessary responses from one or more terminals participating in a group communication.

### BACKGROUND

Wireless communication systems have become a prevalent means to communicate with others worldwide. Wireless communication devices, such as cellular telephones, personal digital assistants, and the like have become smaller and more powerful in order to meet consumer needs and to improve portability and convenience. Consumers have become dependent upon these devices, demanding reliable service, expanded areas of coverage, additional services (e.g., web browsing capabilities), and continued reduction in size and cost of such devices.

A typical wireless communication (e.g., employing frequency, time, and code division techniques) includes one or more base stations that provides coverage areas to subscribers as well as mobile (e.g., wireless) devices that can transmit and receive data within the coverage areas. A typical base station can simultaneously transmit multiple data streams to multiple devices for broadcast, multicast, and/or unicast services, wherein a data stream is a stream of data that can be of independent reception interest to a user device. A user device within the coverage area of that base station can be interested in receiving one, more than one or all the data streams carried by the composite stream. Likewise, a user device can transmit data to the base station or another user device.

In a typical communication system, several nodes, for example mobile terminal, base station and network servers (home agents) communicate with each other. A mobile terminal communicates with base station via a wireless link. The base station may be in communication with network servers via either wired or wireless link.

Multicast technology provides an efficient delivery service for group communications (e.g., one-to-many and/or many-to-many). The use of multicast reduces the bandwidth utilization for group communications. This is especially important for supporting group communications over wireless media, where bandwidth is a scarce resource. In a wireless network, e.g., cellular network, multicast communication mechanisms may be used to send common information from an access node (e.g., base station, access point, access network, home agent, etc.), to a plurality of end nodes (e.g., mobile terminal, access terminal, wireless terminals, etc.).

In some group communication applications a forward signal, e.g., request message or data message, is multicast from a first node to a plurality of other nodes, e.g., group members, and require that at least one of the recipient nodes return a feedback signal, e.g., response message, acknowledgement, or negative acknowledgement. In such cases feedback suppression techniques can be used to limit the number of feedback signals, e.g., messages. For example, upon reception of the forward signal, each recipient can select a random time at which to send a feedback signal, and then only send said feedback signal if the previously selected time is reached prior to having received a feedback signal sent by another recipient of the forward signal. Thus, typically only one recipient of the forward signal, e.g., the one that selected the shortest feedback time, will send a feedback signal, while the other recipients of the forward signal will suppress sending a feedback signal upon receiving the feedback signal sent by the initial responder. This assumes that the feedback signal sent by one recipient of the forward signal can be received by the other recipients of the forward signal, e.g., the feedback signal(s) are also multicast to the group. Examples of this type of signaling exchange include group management query/report message exchanges, e.g., using the Internet Group Management Protocol, and reliable multicast data delivery mechanisms data/acknowledgement or data/negative acknowledgement message exchanges.

Often a communication system employs a multicast system, a group is set up for one or more terminals to join and receive a broadcast from the base station. A multicast is a one way communication system, wherein those terminals that joined a group, will receive information from the base station without specifically requesting that information. On the terminal side, only receive resources are required to be set up. The base station, continuously broadcast this information to the group.

In a multicast system that has established a group comprising one or more terminals. Since, multicast is a one way communication system, when a terminal looses connections for user of the terminal leave the group, the base station will not be notified. Thus, the base station is not aware of the number of terminals listening to the broadcast. It is also, possible that there are no users left in the group. When there are no users left in the group, the BS is simply wasting the broadcast and resources.

Thus, various mechanisms are used to determine if the terminals continue to desire to be part joined group. Base station. The base station periodically broadcast a keep alive request message asking if there are any users still listening to the broadcast. This type of request requires each user to set up a communication link to the base station in order to transmit the response. If there is no reply, the broadcast and the group will be terminated. However, if one or more users are still listening, each of those terminals will send a reply requesting base station to continue broadcasting within a predetermined time period. Generally, each terminal will randomly select a time within the predetermined period when to send the reply so that not all the terminals are sending the reply at once. The broadcasting base station only need to know that at least one terminal is still listening in order for the base station to keep the broadcast alive. Thus, it would inefficient to for each terminal to reply, especially for those terminals that negotiate resources to transmit the reply while others already have resources established. Thus, a mechanism is needed to determine if certain types of user should reply within a shorter time while others reply after a predetermined time has lapses.

### SUMMARY

In accordance with various embodiments, a method provided for facilitating receiving a request that requires a reply within a first time, determining a first maximum time to reply using a first criteria, wherein the maximum time to reply is less than the first time, and selecting a reply time, wherein the reply time is not greater than the maximum time to reply.

### BRIEF DESCRIPTION OF THE DRAWINGS

FIG. 1 illustrates a network diagram of an exemplary communications system.

FIG. 2 illustrates an exemplary access terminal.

FIG. 3 illustrates an exemplary access point.

FIG. 4 illustrates how a maximum time period is divided a communication system according to an aspect.

FIG. 5 illustrates a flow of a routine according to an aspect of some embodiments.

FIG. 6 illustrates the use of one or more modules to carry out the methodologies 600 according to an aspect of some embodiments.

### DETAILED DESCRIPTION

This aspect relates to communications system and, more particularly, to methods and apparatus for supporting quality of service differentiation between traffic flows in a communication system.

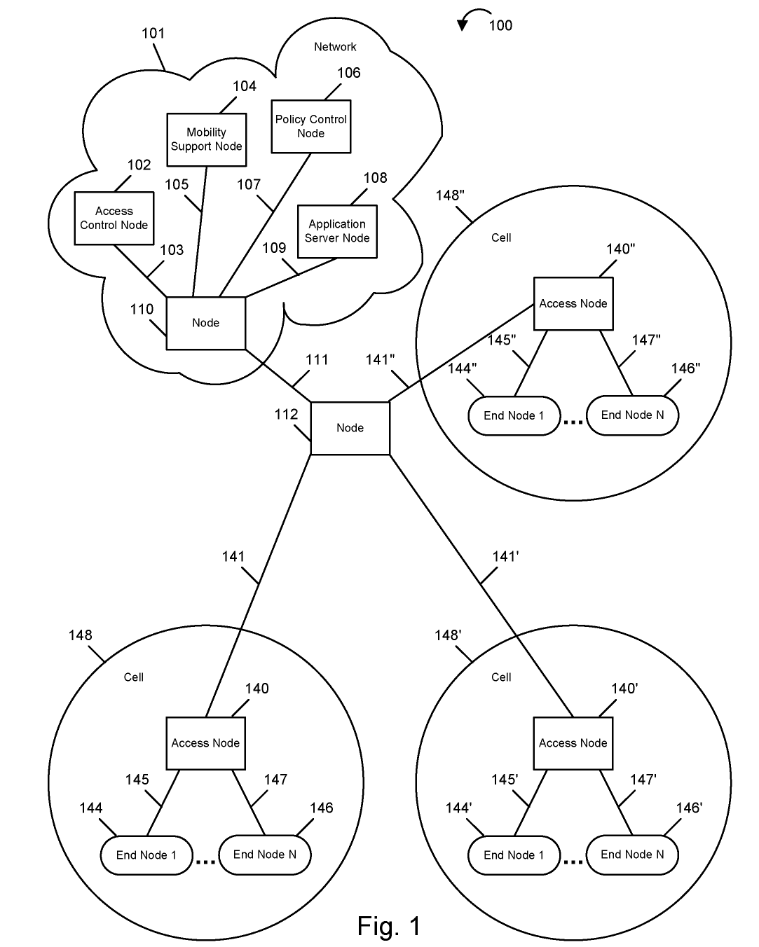

FIG. 1 illustrates an exemplary communication system 100 implemented in accordance with the, e.g., a cellular communication network, which comprises a plurality of nodes interconnected by communications links. The network may use Orthogonal Frequency Division Multiplexing (OFDM) signals to communicate information over wireless links. However, other types of signals, e.g., Code Division Multiple Access (CDMA) signals or Time Division Multiple Access (TDMA) signals, might be used instead. Nodes in the exemplary communication system 100 exchange information using signals, e.g., messages, based on communication protocols, e.g., the Internet Protocol (IP). The communications links of the system 100 may be implemented, for example, using wires, fiber optic cables, and/or wireless communications techniques. The exemplary communication system 100 includes a plurality of end nodes (also referred to as access terminals) 144, 146, 144′, 146′, 144″, 146″, which access the communication system via a plurality of access nodes (also referred to as access points) 140, 140′, 140″. The access terminals 144, 146, 144′, 146′, 144″, 146″ may be, e.g., wireless communication devices or terminals, and the access points 140, 140′, 140″ may be, e.g., wireless access routers or base stations. The exemplary communication system 100 also includes a number of other nodes 102, 104, 106, 108, 110, and 112, used to provide interconnectivity or to provide specific services or functions.

The FIG. 1 exemplary system 100 depicts a network 101 that includes an access control node 102, a mobility support node 104, a policy control node 106, and an application server node 108, all of which are connected to an intermediate network node 110 by a corresponding network link 103, 105, 107, and 109, respectively. In some embodiments, the access control node, e.g., a Remote Authentication Dial In User Service (RADIUS) or Diameter server, supports authentication, authorization, and/or accounting of access terminals and/or services associated with access terminals. In some embodiments, the mobility support node, e.g., a Mobile IP home agent and/or context transfer server, supports mobility, e.g., handoff, of access terminals between access points, e.g., via redirection of traffic to/from access terminals and/or transfer of state associated with access terminals between access points. In some embodiments, the policy control node, e.g., a policy server or Policy Decision Point (PDP), supports policy authorization for services or application layer sessions. In some embodiments, the application server node, e.g., a Session Initiation Protocol server, streaming media server, or other application layer server, supports session signaling for services available to access terminals and/or provides services or content available to access terminals.

The intermediate network node 110 in the network 101 provides interconnectivity to network nodes that are external from the perspective of the network 101 via network link 111. Network link 111 is connected to another intermediate network node 112, which provides further connectivity to a plurality of access points 140, 140′, 140″ via network links 141, 141′, 141″, respectively.

Each access point 140, 140′, 140″ is depicted as providing connectivity to a plurality of N access terminals (144, 146), (144′, 146′), (144″, 146″), respectively, via corresponding access links (145, 147), (145′, 147′), (145″, 147″), respectively. In the exemplary communication system 100, each access point 140, 140′, 140″ is depicted as using wireless technology, e.g., wireless access links, to provide access. A radio coverage area, e.g., communications cell, 148, 148′, 148″ of each access point 140, 140′, 140″, respectively, is illustrated as a circle surrounding the corresponding access point.

The exemplary communication system 100 is subsequently used as a basis for the description of various embodiments. Alternative embodiments of the aspect include various network topologies, where the number and type of nodes (including network nodes, access points, access terminals, as well as various control, support, and server nodes), the number and type of links, and the interconnectivity between various nodes may differ from that of the exemplary communication system 100 depicted in FIG. 1.

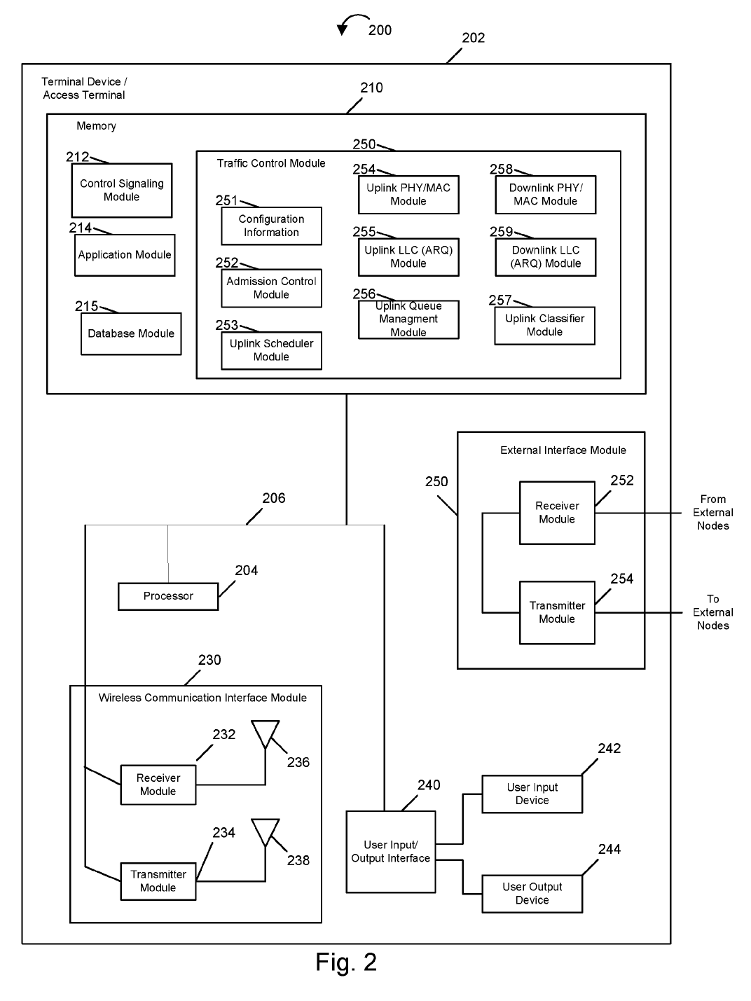

FIG. 2 provides a detailed illustration of an exemplary access terminal 200, e.g., wireless terminal. The exemplary access terminal 200, depicted in FIG. 2, is a detailed representation of an apparatus that may be used as any one of the access terminals 144, 146, 144′, 146′, 144″, 146″, depicted in FIG. 1. According to an aspect, in the FIG. 2 embodiment, the access terminal 200 includes a processor 204, a wireless communication interface module 230, a user input/output interface 240 and memory 210 coupled together by bus 206. Accordingly, via bus 206 the various components of the access terminal 200 can exchange information, signals and data. The components 204, 206, 210, 230, 240 of the access terminal 200 are located inside a housing 202.

The wireless communication interface module 230 provides a mechanism by which the internal components of the access terminal 200 can send and receive signals to/from external devices and network nodes, e.g., access points. The wireless communication interface module 230 includes, e.g., a receiver module 232 with a corresponding receiving antenna 236 and a transmitter module 234 with a corresponding transmitting antenna 238 used for coupling the access terminal 200 to other network nodes, e.g., via wireless communications channels.

The exemplary access terminal 200 also includes a user input device 242, e.g., keypad, and a user output device 244, e.g., display, which are coupled to bus 206 via the user input/output interface 240. Thus, user input/output devices 242, 244 can exchange information, signals and data with other components of the access terminal 200 via user input/output interface 240 and bus 206. The user input/output interface 240 and associated devices 242, 244 provide a mechanism by which a user can operate the access terminal 200 to accomplish various tasks. In particular, the user input device 242 and user output device 244 provide the functionality that allows a user to control the access terminal 200 and applications, e.g., modules, programs, routines and/or functions, that execute in the memory 210 of the access terminal 200.

The processor 204 under control of various modules, e.g., routines, included in memory 210 controls operation of the access terminal 200 to perform various signaling and processing. The modules included in memory 210 are executed on startup or as called by other modules. Modules may exchange data, information, and signals when executed. Modules may also share data and information when executed. In the FIG. 2 embodiment, the memory 210 of access terminal 200 of the includes a control signaling module 212, an application module 214, and a traffic control module 250, which further includes configuration information 251 and various additional modules 252, 253, 254, 255, 256, 257, 258, and 259.

The control signaling module 212 controls processing relating to receiving and sending signals, e.g., messages, for controlling operation and/or configuration of various aspects of the access terminal 200 including, e.g., the traffic control module 250 as well as the configuration information 251 and the various additional modules included therein 252, 253, 254, 255, 256, 257, 258, and 259. In some embodiments of the, the control signaling module 212 includes state information, e.g., parameters, status and/or other information, relating to operation of the access terminal 200 and/or one or more signaling protocols supported by the control signaling module 212. In particular, the control signaling module 212 may include configuration information, e.g., access terminal identification information and/or parameter settings, and operational information, e.g., information about current processing state, status of pending message transactions, etc.

The application module 214 controls processing and communications relating to one or more applications supported by the access terminal 200. In some embodiments of the aspect, application module 214 processing includes tasks relating to input/output of information via the user input/output interfaces 240, manipulation of information associated with an application, and/or receiving or sending signals, e.g., messages, associated with an application. In some embodiments, the application module 214 includes state information, e.g., parameters, status and/or other information, relating to operation of one or more applications supported by the application module 214. In particular, the application module 214 may include configuration information, e.g., user identification information and/or parameter settings, and operational information, e.g., information about current processing state, status of pending responses, etc. Applications supported by the application module 214 include, e.g., Voice over IP (VoIP), web browsing, streaming audio/video, instant messaging, file sharing, gaming, etc.

The database module 215 holds the information about the processes according to an aspect of some embodiments. For example, the database module 215 is used to storing the designated transmit process, an event look-up table, process registration information, a temporary holding place for envelopes, parameter valued, etc.

The traffic control module 250 controls processing relating to receiving and sending data information, e.g., messages, packets, and/or frames, via the wireless communication interface module 230. The exemplary traffic control module includes configuration information 251 as well as various additional modules 252, 253, 254, 255, 256, 257, 258, and 259 that control various aspects of quality of service for packets and/or traffic flows, e.g., associated sequences of packets. In some embodiments, the traffic control module 250 includes state information, e.g., parameters, status and/or other information, relating to operation of the access terminal 200, the traffic control module 250, and/or one or more of the various additional modules included therein 252, 253, 254, 255, 256, 257, 258, and 259. The configuration information 251, e.g., parameter settings, determines, affects and/or prescribes operation of the traffic control module 250 and/or the various additional modules included therein 252, 253, 254, 255, 256, 257, 258, and 259. The various additional modules are included, in some embodiments, to perform particular functions and operations as needed to support specific aspects of traffic control. In various embodiments, modules may be omitted and/or combined as needed depending on the functional requirements of traffic control. A description of each additional module included in the exemplary traffic control module 250 follows.

The admission control module 252 maintains information relating to resource utilization/availability and determines if sufficient resources are available to support the quality of service requirements of particular traffic flows. Resource availability information maintained by the admission control module 252 includes, e.g., packet and/or frame queuing capacity, scheduling capacity, as well as processing and memory capacity needed to support one or more traffic flows. The control signaling module 212, application module 214, and/or other modules included in the access terminal 200 may, and in some embodiments do, query the admission control module 252 to determine if sufficient resources are available to support a new or modified traffic flow, where the admission control determination is a function of the quality of service requirements of the particular traffic flow and/or the available resources. The configuration information 251 may, and in some embodiments does, include configuration information, e.g., parameters settings, that affect the operation of the admission control module 252, e.g., an admission control threshold value that indicates the percentage of resource that may be allocated prior to rejecting additional requests.

The uplink scheduler module 253 controls processing relating to transmission scheduling, e.g., order and/or timing, and allocation of transmission resources, e.g., information coding rate, transmission time slots, and/or transmission power, for data information, e.g., messages, packets, and/or frames, to be sent via the wireless interface module 230, e.g., from the access terminal 200 to an access point. The uplink scheduler module 253 may, and in some embodiments does, schedule transmissions and allocate transmission resources as a function of the quality of service requirements and/or constraints associated with one or more traffic flows. The configuration information 251 may, and in some embodiments does, include configuration information, e.g., parameters settings, that affect the operation of the uplink scheduler module 253, e.g., a priority, rate bound, latency bound, and/or sharing weight associated with one or more traffic flows. In some embodiments of the aspect, scheduling and/or resource allocation operations performed by the uplink scheduler module 253 are additionally a function of channel conditions and other factors, e.g., power budget.

The uplink PHY/MAC module 254 controls physical (PHY) layer and Media Access Control (MAC) layer processing relating to sending data information, e.g., messages, packets, and/or frames, via the wireless communication interface module 230, e.g., from the access terminal 200 to an access point. In some embodiments of the aspect, operation of the uplink PHY/MAC module 254 includes both sending and receiving control information, e.g., signals or messages, to coordinate sending of data information, e.g., messages, packets, or frames. The configuration information 251 may, and in some embodiments does, include configuration information, e.g., parameters settings, that affect the operation of the uplink PHY/MAC module 254, e.g., a frequency, band, channel, spreading code or hoping code to be used for transmissions, an identifier associated with the access terminal 200, a request dictionary prescribing use of an assignment request channel, etc.

The uplink Logical Link Control (ARQ) module 255 controls Logical Link Control (LLC) layer processing relating to sending data information, e.g., messages, packets, and/or frames, via the wireless communication interface module 230, e.g., from the access terminal 200 to an access point. The uplink LLC (ARQ) module 255 includes processing associated with Automatic Repeat Request (ARQ) capabilities, e.g., retransmission of lost packets or frames. In some embodiments of the aspect, the uplink LLC (ARQ) module 255 further includes processing relating to the addition of an LLC header and/or trailer to higher layer messages, e.g., packets, to provide additional functionality, e.g., multi-protocol multiplexing/demultiplexing via a type field or error detection via a checksum field. The uplink LLC (ARQ) module 255 may also, and in some embodiments does, perform fragmentation of higher layer messages, e.g., packets, into multiple sub-portions, e.g., frames to be sent by the uplink PHY/MAC module 254. The configuration information 251 may, and in some embodiments does, include configuration information, e.g., parameters settings, that affect the operation of the uplink LLC (ARQ) module 255, e.g., an ARQ window size, maximum number of retransmissions, a discard timer, etc.

The uplink queue management module 256 maintains information and controls processing relating to storage of data information, e.g., messages, packets, and/or frames, to be sent via the wireless communication interface module 230, e.g., from the access terminal 200 to an access point. The uplink queue management module 256 may, and in some embodiments does, control storage of data information awaiting transmission and maintain state information regarding data information awaiting transmission on a per traffic flow basis, e.g., packets associated with each traffic flow may be stored in separate queues. In some embodiments of the aspect, the uplink queue management module 256 supports a variety of queue management techniques and/or capabilities, e.g., head drop, tail drop, as well as various Active Queue Management (AQM) mechanisms such as Random Early Detection (RED). The configuration information 251 may, and in some embodiments does, include configuration information, e.g., parameters settings, that affect the operation of the uplink queue management module 256, e.g., a queue limit, drop strategy, and/or AQM thresholds associated with one or more traffic flows.

The uplink classifier module 257 controls processing relating to identification of data information, e.g., messages, packets, and/or frames, as belonging to particular traffic flows prior to being sent via the wireless communication interface module 230, e.g., from the access terminal 200 to an access point. In some embodiments of the aspect, messages, packets, and/or frames to be sent via the wireless communication interface module 230 are classified as belonging to one of a variety of traffic flows by the uplink classifier module 257 based on inspection of one or more header and/or payload fields. The results of classification by the uplink classifier module 257 may, and in some embodiments do, affect the treatment of the classified data information, e.g., messages, packets, and/or frames, by the uplink queue management module 256 and other modules 253, 254, 255, e.g., the results may determine a particular queue the message, packet, and/or frame will be associated with for storage and further affect subsequent processing such as scheduling. The configuration information 251 may, and in some embodiments does, include configuration information, e.g., parameters settings, that affect the operation of the uplink classifier module 257, e.g., a set of one or more classifier filter rules that prescribe criteria used to associate data information, e.g., messages, packets, and/or frames, as belonging to one or more traffic flows.

The downlink PHY/MAC module 258 controls PHY layer and MAC layer processing relating to receiving data information, e.g., packets and/or frames, via the wireless communication interface module 230, e.g., from an access point to the access terminal 200. In some embodiments of the aspect, operation of the downlink PHY/MAC module 258 includes both sending and receiving control information, e.g., signals or messages, to coordinate receiving of data information, e.g., messages, packets, or frames. The configuration information 251 may, and in some embodiments does, include configuration information, e.g., parameters settings, that affect the operation of the downlink PHY/MAC module 258, e.g., a frequency, band, channel, spreading code or hoping code to be used for reception, an identifier associated with the access terminal 200, etc.

The downlink LLC (ARQ) module 259 controls LLC layer processing relating to receiving data information, e.g., packets and/or frames, via the wireless communication interface module 230, e.g., from an access point to the access terminal 200. The downlink LLC (ARQ) module 259 includes processing associated with ARQ capabilities, e.g., retransmission of lost packets or frames. In some embodiments of the aspect, the downlink LLC (ARQ) module 259 further includes processing relating to an LLC header and/or trailer that encapsulates higher layer messages, e.g., packets, which provides additional functionality, e.g., multi-protocol multiplexing/demultiplexing via a type field or error detection via a checksum field. The downlink LLC (ARQ) module 259 may also, and in some embodiments does, perform reassembly of frames received by the downlink PHY/MAC module 258 into higher layer messages, e.g., packets. The configuration information 251 may, and in some embodiments does, include configuration information, e.g., parameters settings, that affect the operation of the downlink LLC (ARQ) module 259, e.g., an ARQ window size, maximum number of retransmissions, a discard timer, etc.

The external interface module 250 controls the data received and transmitted to one or more external devices (external nodes). The external interface module 250 comprises a receiver module 252 for receiving information from an external device. The receiver module interface may be an antenna, a USB slot, Ethernet slot, etc. In aspect, the receiver module may also comprise a set of RX modules (RX processor, Demodulator, decryptor, etc.) for receiving a wireless signal, data packets and messages over the air. The external interfaces module 250, further comprises an transmitter module 254. In an aspect, the transmitter module 254 comprises a set of TX modules (TX processor, Modulator, encryptor, etc.) for transmitting a wireless signal, data packets and message over the air. In an aspect, the USB slot, Ethernet slot, etc. may be used to wirelessly communicate with the external devices.

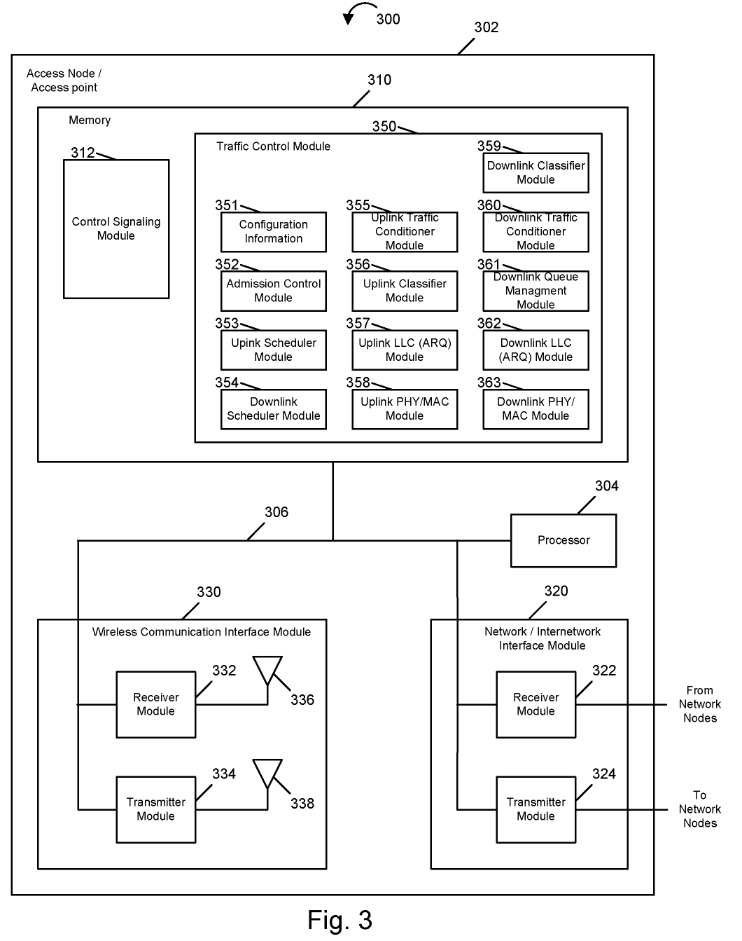

FIG. 3 provides a detailed illustration of an exemplary access point 300 implemented in accordance with the aspect of some embodiments. The exemplary access point 300, depicted in FIG. 3, is a detailed representation of an apparatus that may be used as any one of the access points 140, 140′, 140″ depicted in FIG. 1. In the FIG. 3 embodiment, the access point 300 includes a processor 304, memory 310, a network/internetwork interface module 320 and a wireless communication interface module 330, coupled together by bus 306. Accordingly, via bus 306 the various components of the access point 300 can exchange information, signals and data. The components 304, 306, 310, 320, 330 of the access point 300 are located inside a housing 302.

The network/internetwork interface module 320 provides a mechanism by which the internal components of the access point 300 can send and receive signals to/from external devices and network nodes. The network/internetwork interface module 320 includes, a receiver module 322 and a transmitter module 324 used for coupling the node 300 to other network nodes, e.g., via copper wires or fiber optic lines. The wireless communication interface module 330 also provides a mechanism by which the internal components of the access point 300 can send and receive signals to/from external devices and network nodes, e.g., access terminals. The wireless communication interface module 330 includes, e.g., a receiver module 332 with a corresponding receiving antenna 336 and a transmitter module 334 with a corresponding transmitting antenna 338. The wireless communication interface module 330 is used for coupling the access point 300 to other nodes, e.g., via wireless communication channels.

The processor 304 under control of various modules, e.g., routines, included in memory 310 controls operation of the access point 300 to perform various signaling and processing. The modules included in memory 310 are executed on startup or as called by other modules. Modules may exchange data, information, and signals when executed. Modules may also share data and information when executed. In the FIG. 3 embodiment, the memory 310 of access point 300 of the includes a control signaling module 312 and a traffic control module 350, which further includes configuration information 351 and various additional modules 352, 353, 354, 355, 356, 357, 358, 359, 360, 361, 362, and 363.

The control signaling module 312 controls processing relating to receiving and sending signals, e.g., messages, for controlling operation and/or configuration of various aspects of the access point 300 including, e.g., the traffic control module 350 as well as the configuration information 351 and the various additional modules included therein 352, 353, 354, 355, 356, 357, 358, 359, 360, 361, 362, and 363. In some embodiments of the aspect, the control signaling module 312 includes state information, e.g., parameters, status and/or other information, relating to operation of the access point 300 and/or one or more signaling protocols supported by the control signaling module 312. In particular, the control signaling module 312 may include configuration information, e.g., access point identification information and/or parameter settings, and operational information, e.g., information about current processing state, status of pending message transactions, etc.

The traffic control module 350 controls processing relating to receiving and sending data information, e.g., messages, packets, and/or frames, via the wireless communication interface module 330. The exemplary traffic control module includes configuration information 351 as well as various additional modules 352, 353, 354, 355, 356, 357, 358, 359, 360, 361, 362, and 363 that control various aspects of quality of service for packets and/or traffic flows, e.g., associated sequences of packets. In some embodiments of the aspect, the traffic control module 350 includes state information, e.g., parameters, status and/or other information, relating to operation of the access point 300, the traffic control module 350, and/or one or more of the various additional modules included therein 352, 353, 354, 355, 356, 357, 358, 359, 360, 361, 362, and 363. The configuration information 351, e.g., parameter settings, determines, affects and/or prescribes operation of the traffic control module 350 and/or the various additional modules included therein 352, 353, 354, 355, 356, 357, 358, 359, 360, 361, 362, and 363. The various additional modules are included, in some embodiments, to perform particular functions and operations as needed to support specific aspects of traffic control. In various embodiments of the aspect, modules may be omitted and/or combined as needed depending on the functional requirements of traffic control. A description of each additional module included in the exemplary traffic control module 350 follows.

The admission control module 352 maintains information relating to resource utilization/availability and determines if sufficient resources are available to support the quality of service requirements of particular traffic flows. Resource availability information maintained by the admission control module 352 includes, e.g., packet and/or frame queuing capacity, scheduling capacity, as well as processing and memory capacity needed to support one or more traffic flows. The control signaling module 312 and/or other modules included in the access point 300 may, and in some embodiments do, query the admission control module 352 to determine if sufficient resources are available to support a new or modified traffic flow, where the admission control determination is a function of the quality of service requirements of the particular traffic flow and/or the available resources. The configuration information 351 may, and in some embodiments does, include configuration information, e.g., parameters settings, that affect the operation of the admission control module 352, e.g., an admission control threshold value that indicates the percentage of resource that may be allocated prior to rejecting additional requests.

The uplink scheduler module 353 controls processing relating to transmission scheduling, e.g., order and/or timing, and allocation of transmission resources, e.g., information coding rate, transmission time slots, and/or transmission power, for data information, e.g., messages, packets, and/or frames, to be sent from one or more access terminals to the access point via the wireless interface module 330. The uplink scheduler module 353 may, and in some embodiments does, schedule transmissions and allocate transmission resources as a function of the quality of service requirements and/or constraints associated with one or more traffic flows and/or one or more access terminals. The configuration information 351 may, and in some embodiments does, include configuration information, e.g., parameters settings, that affect the operation of the uplink scheduler module 353, e.g., a priority, rate bound, latency bound, and/or sharing weight associated with one or more traffic flows and/or access terminals. In some embodiments of the aspect, scheduling and/or resource allocation operations performed by the uplink scheduler module 353 are additionally a function of channel conditions and other factors, e.g., power budget.

The downlink scheduler module 354 controls processing relating to transmission scheduling, e.g., order and/or timing, and allocation of transmission resources, e.g., information coding rate, transmission time slots, and/or transmission power, for data information, e.g., messages, packets, and/or frames, to be sent from the access point 300 to one or more access terminals via the wireless interface module 330. The downlink scheduler module 354 may, and in some embodiments does, schedule transmissions and allocate transmission resources as a function of the quality of service requirements and/or constraints associated with one or more traffic flows and/or one or more access terminals. The configuration information 351 may, and in some embodiments does, include configuration information, e.g., parameters settings, that affect the operation of the downlink scheduler module 354, e.g., a priority, rate bound, latency bound, and/or sharing weight associated with one or more traffic flows and/or access terminals. In some embodiments of the aspect, scheduling and/or resource allocation operations performed by the downlink scheduler module 354 are additionally a function of channel conditions and other factors, e.g., power budget.

The uplink traffic conditioner module 355 controls processing relating to traffic conditioning, e.g., metering, marking, policing, etc., for data information, e.g., messages, packets, and/or frames, received via the wireless interface module 330, e.g., from an access terminal to the access point 300. The uplink traffic conditioner module 355 may, and in some embodiments does, condition traffic, e.g., meter, mark and/or police, as a function of the quality of service requirements and/or constraints associated with one or more traffic flows and/or one or more access terminals. The configuration information 351 may, and in some embodiments does, include configuration information, e.g., parameters settings, that affect the operation of the uplink traffic conditioner module 355, e.g., a rate bound, and/or marking value associated with one or more traffic flows and/or access terminals.

The uplink classifier module 356 controls processing relating to identification of data information, e.g., messages, packets, and/or frames, received via the wireless interface module 330, e.g., from an access terminal to the access point 300, as belonging to particular traffic flows prior to being processed by uplink traffic conditioner module 355. In some embodiments of the aspect, messages, packets, and/or frames received via the wireless communication interface module 330 are classified as belonging to one of a variety of traffic flows by the uplink classifier module 356 based on inspection of one or more header and/or payload fields. The results of classification by the uplink classifier module 356 may, and in some embodiments do, affect the treatment of the classified data information, e.g., messages, packets, and/or frames, by the uplink traffic conditioner module 355, e.g., the results may determine a particular data structure or state machine the message, packet, and/or frame will be associated with and further affect subsequent processing such as metering, marking, and/or policing. The configuration information 351 may, and in some embodiments does, include configuration information, e.g., parameters settings, that affect the operation of the uplink classifier module 356, e.g., a set of one or more classifier filter rules that prescribe criteria used to associate data information, e.g., messages, packets, and/or frames, as belonging to one or more traffic flows.

The uplink LLC (ARQ) module 357 controls LLC layer processing relating to receiving data information, e.g., packets and/or frames, via the wireless communication interface module 330, e.g., from an access terminal to the access point 300. The uplink LLC (ARQ) module 357 includes processing associated with ARQ capabilities, e.g., retransmission of lost packets or frames. In some embodiments of the aspect, the uplink LLC (ARQ) module 357 further includes processing relating to an LLC header and/or trailer that encapsulates higher layer messages, e.g., packets, which provides additional functionality, e.g., multi-protocol multiplexing/demultiplexing via a type field or error detection via a checksum field. The uplink LLC (ARQ) module 357 may also, and in some embodiments does, perform reassembly of frames received by the uplink PHY/MAC module 358 into higher layer messages, e.g., packets. The configuration information 251 may, and in some embodiments does, include configuration information, e.g., parameters settings, that affect the operation of the uplink LLC (ARQ) module 357, e.g., an ARQ window size, maximum number of retransmissions, a discard timer, etc.

The uplink PHY/MAC module 358 controls PHY layer and MAC layer processing relating to receiving data information, e.g., packets and/or frames, via the wireless communication interface module 330, e.g., from an access terminal to the access point 300. In some embodiments of the aspect, operation of the uplink PHY/MAC module 358 includes both sending and receiving control information, e.g., signals or messages, to coordinate receiving of data information, e.g., messages, packets, or frames. The configuration information 351 may, and in some embodiments does, include configuration information, e.g., parameters settings, that affect the operation of the uplink PHY/MAC module 358, e.g., a frequency, band, channel, spreading code or hoping code to be used for reception, an identifier associated with the access point 300, etc.

The downlink classifier module 359 controls processing relating to identification of data information, e.g., messages, packets, and/or frames, as belonging to particular traffic flows prior to being sent via the wireless communication interface module 330, e.g., from the access point 300 to an access terminal. In some embodiments of the aspect, messages, packets, and/or frames to be sent via the wireless communication interface module 330 are classified as belonging to one of a variety of traffic flows by the downlink classifier module 359 based on inspection of one or more header and/or payload fields. The results of classification by the downlink classifier module 359 may, and in some embodiments do, affect the treatment of the classified data information, e.g., messages, packets, and/or frames, by the downlink queue management module 361 and other modules 360, 362, 363, e.g., the results may determine a particular queue the message, packet, and/or frame will be associated with for storage and further affect subsequent processing such as scheduling. The configuration information 351 may, and in some embodiments does, include configuration information, e.g., parameters settings, that affect the operation of the downlink classifier module 359, e.g., a set of one or more classifier filter rules that prescribe criteria used to associate data information, e.g., messages, packets, and/or frames, as belonging to one or more traffic flows.

The downlink traffic conditioner module 360 controls processing relating to traffic conditioning, e.g., metering, marking, policing, etc., for data information, e.g., messages, packets, and/or frames, to be sent via the wireless interface module 330, e.g., from the access point 300 to an access terminal. The downlink traffic conditioner module 360 may, and in some embodiments does, condition traffic, e.g., meter, mark and/or police, as a function of the quality of service requirements and/or constraints associated with one or more traffic flows and/or one or more access terminals. The configuration information 351 may, and in some embodiments does, include configuration information, e.g., parameters settings, that affect the operation of the downlink traffic conditioner module 360, e.g., a rate bound, and/or marking value associated with one or more traffic flows and/or access terminals.

The downlink queue management module 361 maintains information and controls processing relating to storage of data information, e.g., messages, packets, and/or frames, to be sent via the wireless communication interface module 330, e.g., from the access point 300 to an access terminal. The downlink queue management module 361 may, and in some embodiments does, control storage of data information awaiting transmission and maintain state information regarding data information awaiting transmission on a per traffic flow basis, e.g., packets associated with each traffic flow may be stored in separate queues. In some embodiments of the aspect, the downlink queue management 361 module supports a variety of queue management techniques and/or capabilities, e.g., head drop, tail drop, as well as various AQM mechanisms such as RED. The configuration information 351 may, and in some embodiments does, include configuration information, e.g., parameters settings, that affect the operation of the downlink queue management module 361, e.g., a queue limit, drop strategy, and/or AQM thresholds associated with one or more traffic flows.

The downlink LLC (ARQ) module 362 controls LLC layer processing relating to sending data information, e.g., messages, packets, and/or frames, via the wireless communication interface module 330, e.g., from the access point 300 to an access terminal. The downlink LLC (ARQ) module 362 includes processing associated with ARQ capabilities, e.g., retransmission of lost packets or frames. In some embodiments of the aspect, the downlink LLC (ARQ) module 362 further includes processing relating to the addition of an LLC header and/or trailer to higher layer messages, e.g., packets, to provide additional functionality, e.g., multi-protocol multiplexing/demultiplexing via a type field or error detection via a checksum field. The downlink LLC (ARQ) module 362 may also, and in some embodiments does, perform fragmentation of higher layer messages, e.g., packets, into multiple sub-portions, e.g., frames to be sent by the downlink PHY/MAC module 363. The configuration information 351 may, and in some embodiments does, include configuration information, e.g., parameters settings, that affect the operation of the downlink LLC (ARQ) module 362, e.g., an ARQ window size, maximum number of retransmissions, a discard timer, etc.

The downlink PHY/MAC module 363 controls PHY layer and MAC layer processing relating to sending data information, e.g., messages, packets, and/or frames, via the wireless communication interface module 330, e.g., from the access point 300 to an access terminal. In some embodiments of the aspect, operation of the downlink PHY/MAC module 363 includes both sending and receiving control information, e.g., signals or messages, to coordinate sending of data information, e.g., messages, packets, or frames. The configuration information 351 may, and in some embodiments does, include configuration information, e.g., parameters settings, that affect the operation of the downlink PHY/MAC module 363, e.g., a frequency, band, channel, spreading code or hoping code to be used for transmissions, an identifier associated with the access point 300, etc.

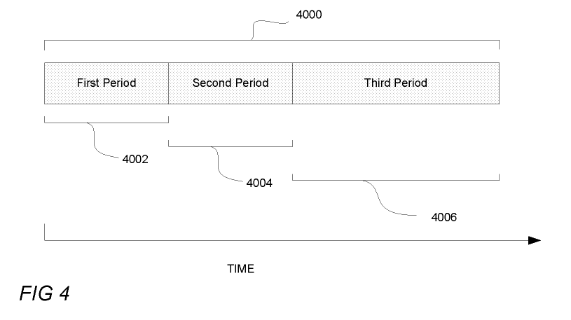

FIG. 4 illustrates how a maximum time period 4000 to respond to a “keep alive” request (KAReq) message is divided. In aspect, when a base station transmits a KAReq message to all the terminals to determine if any terminal is listening to the broadcast. Depending on the deployment of the system, a predetermined maximum time to respond comprises a predetermined delta (T_{D}) that is added to the time of request (T_{REQ}). Thus, at least one terminal must reply within a response period (P_{RESP}) 4000, wherein P_{RESP}=T_{REQ}+T_{D}. In an aspect, the maximum time to reply is determined by using a criteria selected from a list of criteria such as remaining battery life criteria, distance criteria, required power criteria or terminal's state criteria. For each criterion, the maximum time and measured valued used to calculate the maximum time may be different.

In an aspect, the response period 4000 may be divided into three periods, first period (P_{first}) 4002, second period (P_{second}) 4004 and third period (P_{third}) 4006. Each period comprising a start time (e.g. T_{first-start}, T_{second-start} and T_{third-start}) and an end time (T_{first-end}, T_{second-end} and T_{third-end}), wherein the end time for each period represents the maximum time to reply for that period. For example, first period is P_{first}=T_{first-start}+T_{first-end}, second period is P_{second}=T_{second-start}+T_{second-end}, and third period is P_{third}=T_{third-start}+T_{third-end}, wherein P_{first}<P_{second}<P_{third}.

Depending on the deployment of the system, each terminal may be grouped and assigned to a period based on one or more factors, for example, the state (ON, HOLD, SLEEP, etc.) of the terminal, based on power required (P1, P2, P3, etc), and/or base on terminals distance to the base station (D1, D2, D3, etc.). Other factors may be employed to determine which period a particular terminal should be using to set a reply time and additional periods may be used to determine within which the terminal will reply back to the requestor.

In an aspect, the terminal may be in any one of the states selected from a list of states. In an aspect, the list of states comprises an ON state, HOLD state, SLEEP state, SPLIT state and OFF state. In an aspect, the processor is configured to receive messages from base station while in ON state, HOLD state or SLEEP state. According to an aspect, when a terminal is in the ON state, it is power controlled and timed controlled. It also has exclusive use of an uplink dedicated control channel (ULDCCH) resource. On the ULDCCH resource, the terminal periodically sends measured downlink channel quality information, such as signal-to-noise-ratio (SNR) and carrier to interference (C/I) ratios. The downlink channel quality reports for all MAC ON state terminals are compiled by the base station and used to dynamically determine which terminals to schedule for downlink data transmission. In addition, MAC ON state terminals periodically send a report of traffic queue status, which is used by the base station to determine which terminals to schedule for uplink data transmission. The terminal constantly receives the broadcast assignment channel on the downlink. Once it receives an assignment, the terminal can transmit and receive on the assigned traffic channel segment at the rate (coding and modulation combination) and power level indicated by the base station.

When terminal is in the HOLD state, a terminal is timed controlled, but not power controlled. It has a very “thin” uplink dedicated request channel that it can use to indicate its intention to migrate to the ON state or the SLEEP/HIBERNATE state. This request control channel needs only a fraction of the throughput of the ULDCCH. Moreover, the terminal need transmit on this channel only when it desires to change state (i.e. not continuously). All terminals in HOLD state share a fast paging channel that is used by the base station to signal any particular terminal to transition from the HOLD state to the ON state.

When the terminal is in the SLEEP state, it does not occupy any airlink resources and the device remains in a power saving mode. The terminal is not power-controlled nor timing-controlled. The terminal is able to receive paging messages since it periodically wakes up to check the downlink paging channel. The wake up periodicity is configurable, and may be as small as a beaconslot or ˜90 ms. In order to access the system and receive or transmit user data, the terminal has to go through the Access state.

In an aspect, the terminal will use the first period 4002 to determine the transmit time if the terminal is in a ON state; the terminal will use the second period 4004 to determine the transmit time if the terminal is in a HOLD state; the terminal will use the third period 4006 to determine the transmit time if the terminal is in a SLEEP state.

In an aspect, the terminal will use the first period 4002 to determine the transmit time if the required power is with a first predetermine required power range (P1); the terminal will use the second period 4004 to determine the transmit time if the required power is with a second predetermine required power range (P2); and the terminal will use the third period 4006 to determine the required power is with a third predetermine required power range (P3). The power ranges may be predetermined based on the required power to transmit to the requester (e.g. base stations). In aspect, the power ranges are mutually exclusive, wherein required power in range P1 is less than range P2 and require power in range P2 is less than range P3. Thus, for example, the terminals that require less power to transmit will select a time within first time period to reply.

In an aspect, the terminal will use the first period 4002 to determine the transmit time if the distance to the base stations is with a first predetermine distance range (D1); the terminal will use the second period 4004 to determine the transmit time if the distance to the base stations is with a second predetermine distance range (D2); and the terminal will use the third period 4006 to determine the transmit time if the distance to the base stations is with a third predetermine distance range (D3). The distance ranges may be predetermined based on the distance to the requestor (e.g. base stations). In aspect, the distance ranges are mutually exclusive, wherein the terminal's distance in range D1 is less than range D2 and the terminal's distance in range D2 is less than range D3. Thus, for example, the terminals that are closer to the base station will select a time within first period.

In an aspect, the terminal will use the first period 4002 to determine the transmit time if the remaining battery power is with a first predetermine battery power range; the terminal will use the second period 4004 to determine the transmit time if the remaining battery power is with a second predetermine battery power range; the terminal will use the third period 4006 to determine the transmit time if the remaining battery power is with a third predetermine battery power range. In an aspect, the first predetermine battery power range is based high levels of remaining battery power, the second predetermine battery power range is based on medium levels of remaining battery power and the third predetermined battery power range is based on low levels of remaining battery power. A predetermined battery power delta is used to distinguish high, medium and low levels of remaining battery power.

In another aspect the terminal determines its response time as a function of its remaining battery life (lower the battery life, longer the response time). The terminal will determine the remaining battery life value (B_{life}) as percentage by dividing remaining battery life (B_{remaining}) by maximum battery life (Bₘₐₓ) remaining battery life (B_{life}=B_{remaining}/Bₘₐₓ). Then the terminal may determine the maximum time to reply (T_{MAX-REPLY}) by using the following: T_{MAX-REPLY}=T_{REQ}+(T_{D}*(1−B_{life})). This will allow the terminals with lower battery life to conserve the battery power. In an aspect, T_{MAX-REPLY} may be the actual time to reply. In another aspect, T_{MAX-REPLY} may be determined using a look up table stored in memory. This method of determination may be applied within the first period 4002, second period 4004 or the third period 4006 discussed above by replacing T_{D} with (T_{first-end}, T_{second-end} or T_{third-end}). Once the terminal determines with which period to use, the terminal may determine the maximum time to reply time based on remaining battery life instead of using a random time within each the determined period.

In another aspect, the terminal determines its response time period based on the present mode of operation, e.g., as a function of which of a plurality of power conservation modes the recipient node is in at the time of the initial signal reception. For example, a recipient node that is already in a mode of operation that allows for transmission may select a shorter response time than a recipient node that is in a mode that does not allow for transmission.

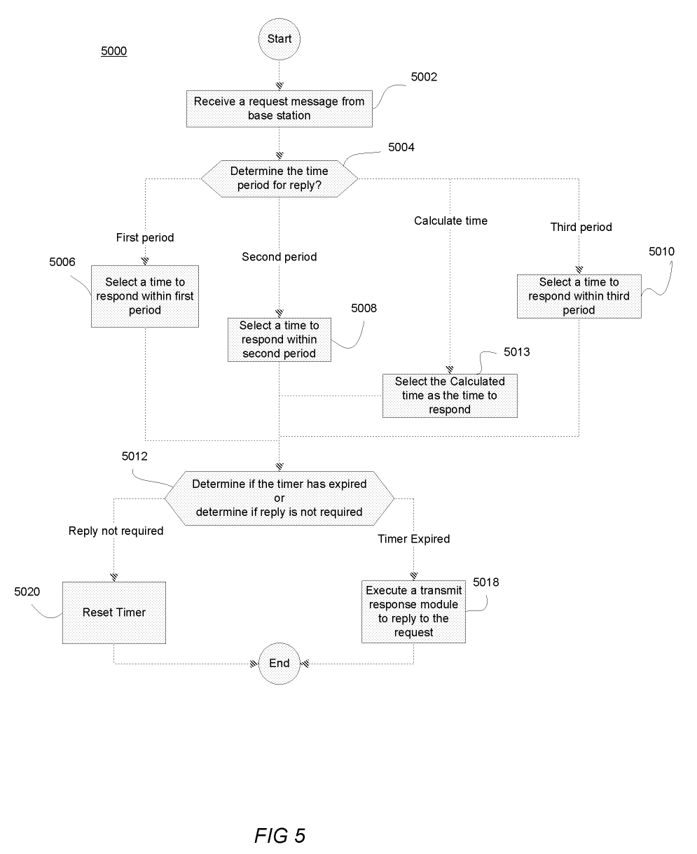

FIG. 5 illustrates a flow diagram of a routine 5000 according to an aspect of some embodiments. Processor may be configured to execute the routine 5000 using logical modules, software objects, memory and other devices. At block 5002, the processor is configured to receive an indication that base station has transmitted a request message that requires a reply. In an aspect, regardless of the state of the terminal, certain types of messages are monitored and processed. For example, broadcast messages are monitored while the terminal continues to be part of a multicast group.

At block 5004, the processor is configured to determine a time period for replying in respond to the base station's request or calculate a time when to the terminal should reply based on a predetermine factor (for example, remaining battery life, distance from base station, etc.). In an aspect, on the deployment of the system, the processor is configured to determine the state of terminal, required power level, distance to base station, and/or remaining battery life in order to determine which time period use (first time period, second time period or third time period) for transmitting a reply (discussed above).

At block 5006, if determined that the terminal is required to transmit during first period, then the processor is configured to select a first period of time 4002 to calculate a time to respond and configured to calculate a time to respond within first period 4002. In an aspect, the processor is configured to calculate the time to respond by selecting a random time within the selected first period of time. At block 5008, if determined that the terminal is required to transmit during second period, then the processor is configured to select a second period of time 4004 to calculate a time to respond and configured to calculate a time to respond within the selected second period 4004. In an aspect, the processor is configured to calculate the time to respond by selecting a random time within second period of time. At block 5010, if determined that the terminal is required to transmit during third period, then the processor is configured to select a third period of time 4006 to calculate a time to respond and configured to calculate a time to respond within the selected third period 4006. In an aspect, the processor is configured to calculate the time to respond by selecting a random time within third period of time. At block 5013, the processor selects a calculated time to respond. The calculate time may be based on the remaining battery life. Various methods may be used to calculate the time, for example, lower the battery life, the longer the terminal waits before replying. This will allow other terminals with more battery life to reply first so that the terminals with lower battery life can converse batter power. Depending the about of battery life remaining, the time to respond may be maximum time to reply.

In an aspect, when a base station receives a reply from at least one terminal, the base station may transmit a message to all the terminals within the group that a reply was received from at least one terminal. Upon receiving this message, the processor is configured to determine that reply is not required. In an aspect of the some embodiments, a reply sent by another terminal to the base station may be received by the terminal and in response; the processor generates an event indicating that a reply to the base station request is not required. If the current time as reached the selected time to reply, then processor generates an event indicating that the timer has expired.

At block 5014, the processor monitors for an event (timer expired or reply not required). Upon receiving an event, the processor determines if the timer has expired or determines if a reply is not required. If determined that timer has expired, then at block 5018, the processor sets up the required resources and transmits a reply message to base station. Otherwise, if determined that the reply is not required, then at block 5020 the processor is configured to reset the timer and wait for the next request from base station.

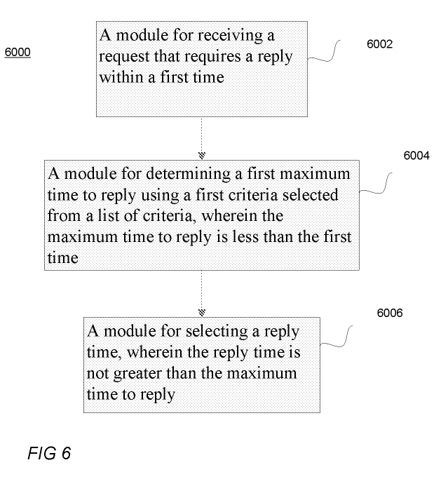

FIG. 6 illustrates a system 6000 that uses logic modules to carry out the methodologies according to an aspect. System 6000 is represented as a series of interrelated functional blocks, which can represent functions implemented by one or more logical modules of a processor, software, or combination thereof (e.g., firmware). At block 6002, a module for receiving a request that requires a reply within a first time. At block 6004, a module for means for determining a first maximum time to reply using a first criteria selected from a list of criteria, wherein the maximum time to reply is less than the first time. At block 6006, a module for selecting a reply time, wherein the reply time is not greater than the maximum time to reply.

Messages described in the present patent application are stored in the memory of the nodes which generate and/or receive said messages in addition to the nodes through which said messages are communicated. Accordingly, in addition to being directed to methods and apparatus for generating, transmitting and using novel messages of the, the is also directed to machine readable media, e.g., memory, which stores one or more of the novel messages of the type described and shown in the text and figures of the present application.

In various embodiments, nodes described herein are implemented using one or more modules to perform the steps corresponding to one or more methods of the aspect, for example, signal processing, message generation and/or transmission steps. Thus, in some embodiments various features of the are implemented using modules. Such modules may be implemented using software, hardware or a combination of software and hardware. Many of the above described methods or method steps can be implemented using machine executable instructions, such as software, included in a machine readable medium such as a memory device, e.g., RAM, floppy disk, etc. to control a machine, e.g., general purpose computer with or without additional hardware, to implement all or portions of the above described methods, e.g., in one or more nodes. Accordingly, among other things, the aspect is directed to a machine-readable medium including machine executable instructions for causing a machine, e.g., processor 304 and associated hardware, to perform one or more of the steps of the above-described method(s).

Numerous additional variations on the methods and apparatus of the aspects described above will be apparent to those skilled in the art in view of the above description of the aspect. Such variations are to be considered within the scope of the aspect. The methods and apparatus of the aspects may be, and in various embodiments are, used with OFDM, CDMA, TDMA or various other types of communications techniques which may be used to provide wireless communications links between access nodes and mobile nodes. In some embodiments the access nodes are implemented as base stations which establish communications links with mobile nodes using OFDM, CDMA and/or TDMA. In various embodiments the mobile nodes are implemented as notebook computers, PDAs, or other portable devices including receiver/transmitter circuits and logic and/or routines, for implementing the methods of the aspects described above.

What is claimed is:

1. An apparatus operable in a group communication system, the apparatus comprising:
means for receiving a request that requires a reply within a first time;
means for determining a first maximum time to reply using a first criteria, wherein the maximum time to reply is less than the first time; and
means for selecting a reply time, wherein the reply time is not greater than the maximum time to reply.

2. The apparatus as claimed in claim 1, wherein the first criteria is selected from a list of criteria.

3. The apparatus as claimed in claim 2, wherein the list of criteria comprises a remaining battery life criteria, a distance criteria, a required power criteria and a terminal's state criteria.

4. The apparatus as claimed in claim 3, wherein the first criteria comprises a terminal's state criteria.

5. The apparatus as claimed in claim 3, wherein the means for selecting the reply time comprises of selecting the maximum time to reply as the reply time if determined that first criteria is remaining battery life criteria.

6. The apparatus as claimed in claim 3, wherein the terminal's state criteria comprises a ON state, a HOLD state and a SLEEP state.

7. The apparatus as claimed in claim 3, wherein the distance criteria comprises a first range, a second range, and a third range.

8. The apparatus as claimed in claim 3, wherein the required power criteria comprises a first range, a second range, and a third range.

9. The apparatus as claimed in claim 1, further comprising:
means for determining a terminal's state prior to using the first criteria;
means for determining a first start time; and
means for determining a first period using the first start time and the first maximum time.

10. The apparatus as claimed in claim 1, further comprises means for determining a first start time, wherein the first start time is less than the first maximum time.

11. A method used in a group communication system, the method comprising:
receiving a request that requires a reply within a first time;
determining a first maximum time to reply using a first criteria, wherein
the maximum time to reply is less than the first time; and
selecting a reply time, wherein the reply time is not greater than the maximum time to reply.

12. The method as claimed in claim 1, wherein determining the first criteria comprises of selecting the first criteria from a list of criteria.

13. The method as claimed in claim 2, wherein the selecting the list of criteria comprises selecting from a remaining battery life criteria, a distance criteria, a required power criteria and a terminal's state criteria.

14. The method as claimed in claim 3, wherein selecting the first criteria comprises a selecting a terminal's state criteria.

15. The method as claimed in claim 3, wherein the selecting the reply time comprises of selecting the maximum time to reply as the reply time if determined that first criteria is remaining battery life criteria.

16. The method as claimed in claim 3, wherein selecting the terminal's state criteria comprises selecting a ON state, a HOLD state and a SLEEP state.

17. The method as claimed in claim 3, wherein selecting the distance criteria comprises selecting a first range, a second range, and a third range.

18. The method as claimed in claim 3, wherein selecting the required power criteria comprises selecting a first range, a second range, and a third range.

19. The method as claimed in claim 1, further comprising:
determining a terminal's state prior to using the first criteria;
determining a first start time; and
determining a first period using the first start time and the first maximum time.

20. The method as claimed in claim 1, further comprises determining a first start time, wherein the first start time is less than the first maximum time.

21. A machine-readable medium comprising instructions which, when executed by a machine, cause the machine to perform operations including:
determining a terminal's state prior to using the first criteria;
determining a first start time; and
determining a first period using the first start time and the first maximum time.

22. An apparatus operable in a wireless communication system, the apparatus comprising:
a processor, configured for determining a terminal's state prior to using the first criteria, determining a first start time, and determining a first period using the first start time and the first maximum time; and a memory coupled to the processor for storing data.
